(19) United States
(12) Patent Application Publication
(10) Pub. No.: US 2012/0241267 A1
(43) Pub. Date: Sep. 27, 2012

(54) DUST COVER STRUCTURE OF HYDRAULIC SHOCK ABSORBER

(75) Inventor: Nobuyuki MURAGUCHI, Gyoda-shi (JP)

(73) Assignee: SHOWA CORPORATION, Saitama (JP)

(21) Appl. No.: 13/243,037

(22) Filed: Sep. 23, 2011

(30) Foreign Application Priority Data
Jan. 21, 2011 (JP) 2011011252

(51) Int. Cl. F16F 9/38

(52) U.S. Cl. 188/322.12

(57) ABSTRACT

In a dust cover structure of a hydraulic shock absorber 10 covering a piston rod 12 of the hydraulic shock absorber 10 with a bellows-like dust cover 30, the dust cover 30 is divided into upper, intermediate and lower regions A, B, and C extending in a longitudinal direction. Thicknesses Ta and Tc of bellows portions 33A and 33C in the upper region A and the lower region C are made thin, and a thickness Tb of a bellows portion 33B in the intermediate region B is made thick.

### BACKGROUND OF THE INVENTION

1. Field of the Invention

The present invention relates to a dust cover structure of a hydraulic shock absorber.

2. Description of the Related Art

In a hydraulic shock absorber, a piston rod protruding out of an outer tube is covered by a dust cover, thereby preventing mud from being attached to the piston rod and preventing a stone on a road surface from coming into contact therewith. The dust cover is formed by molding a rubber material or the like in a bellows shape, which extends and retracts in accordance with extension and retraction of the piston rod.

In the dust cover, a bellows portion deflects largely to one side in a radial direction in the middle of the compression (hereinafter, referred to as a bowing), and there is a risk that it comes into contact with a coil spring or the like in the periphery so as to be broken.

Accordingly, in a dust cover described in Japanese Patent Application Laid-Open No. 10-159975 (Patent Document 1), a thickness of a vertex portion of the bellows portion is differentiated per each of upper, intermediate and lower regions extending in the longitudinal direction, whereby it is possible to suppress the bowing.

Further, in a dust cover described in Japanese Patent Application Laid-Open No. 10-267124 (Patent Document 2), the bowing can be suppressed by making a height of a ridge (a difference in height between a crest portion and a root portion) of a bellows portion in an end region extending in a longitudinal direction higher than a height of the bellows portion in an intermediate region.

The dust cover described in Patent Document 1 is formed in such a manner that the thickness of the crest portion of the bellows portion is different per each of the regions extending in the longitudinal direction, requires high precision in a molding die and a manufacturing method, and is difficult to manufacture.

The dust cover described in Patent Document 2 is formed in such a manner that the height of the ridge of the bellows portion is different per each of the regions extending in the longitudinal direction, requires high precision in a molding die and a manufacturing method, and is difficult to manufacture.

### SUMMARY OF THE INVENTION

An object of the present invention is to easily manufacture a dust cover which can suppress bowing, in a dust cover structure of a hydraulic shock absorber.

In one embodiment of the present invention, there is provided a dust cover structure of a hydraulic shock absorber covering a piston rod of the hydraulic shock absorber with a bellows-like dust cover. The dust cover is divided into upper, intermediate and lower regions extending in a longitudinal direction. The thicknesses of bellows portions in the upper region and the lower region are made thin, and a thickness of a bellows portion in the intermediate region is made thick.

In another embodiment of the present invention, there is provided a dust cover structure of a hydraulic shock absorber wherein the thickness of the bellows portion in the intermediate region is made 5 to 15% thicker than the thicknesses of the bellows portions in the upper region and the lower region.

In another embodiment of the present invention, there is provided a dust cover structure of a hydraulic shock absorber wherein the hydraulic shock absorber is of a strut type.

In another embodiment of the present invention, there is provided a dust cover structure of a hydraulic shock absorber wherein the dust cover is structured such that upper and lower quarters of a whole length of the bellows portion are set to bellows portions in the upper region and the lower region, respectively, and the remaining half is set to a bellows portion in the intermediate region.

In another embodiment of the present invention, there is provided a dust cover structure of a hydraulic shock absorber wherein the dust cover is structured such that upper and lower thirds of a whole length of the bellows portion are set to bellows portions in the upper region and the lower region, respectively, and the remaining third is set to a bellows portion in the intermediate region.

In accordance with the present embodiment, the following operations and effects can be achieved.

(a) The thicknesses of the bellows portions in the upper region and the lower region are made thin (small rigidity), and the thickness of the bellows portion in the intermediate region is made thick (large rigidity). Accordingly, a whole length of the dust cover is shortened by deflecting the bellows portions in the upper region and the lower region having the small rigidity and being easily deflected in advance, and the bellows portion in the intermediate region having the large rigidity and being hard to deflect is thereafter deflected.

The bellows portions in the upper region and the lower region are easily bent at such a degree that the rigidity is small, but are hard to bend at such a degree that they are shorter in comparison with the whole length of the dust cover, and are immediately folded at such a degree that the rigidity is small, thereby being suppressed from bowing.

The bellows portion in the intermediate region is hard to bow at such a degree that the rigidity is large, is made shorter in comparison with the whole length of the dust cover, and starts being folded after the whole length of the dust cover becomes short. Accordingly, even if only the bellows portion in the intermediate region is deflected to one side in a radial direction, a protruding amount in the radial direction thereof is not large, and it is possible to suppress the bowing.

In other words, the general dust cover has the maximum protruding amount to the radial direction in the intermediate portion in the longitudinal direction so as to tend to generate the bowing. The dust cover starts bending from the bellows portions in the upper region and the lower region, and bends largely by the bellows portion in the intermediate region so as to interfere with the peripheral coil spring or the like. On the contrary, in the present invention, even if the bellows portions in the upper region and the lower region bend to some extent in a process of being folded, the bellows portion in the intermediate region having a large rigidity is not folded yet and does not generate the bowing. Further, if the bellows portions in the upper region and the lower region finish being folded, the remaining short bellows portion in the intermediate region is hard to bend due to the large rigidity, the protruding amount to the radial direction is not large due to the short length, and the bowing is not generated. Accordingly, a whole of the dust cover is inhibited from being bowed and can extend and retract.

(b) It is sufficient to make the thicknesses of the bellows portions in the upper region and the lower region thin as a whole, and make the thickness of the bellows portion in the intermediate region thick as a whole, and a high precision is not required in the molding die and the manufacturing method. It is possible to easily manufacture the dust cover which can suppress the bowing.

(c) The thickness of the bellows portion in the intermediate region is made 5 to 15% thicker than the thicknesses of the bellows portions in the upper region and the lower region. It is possible to securely suppress the bowing of the dust cover by the item (a) mentioned above.

(d) When the hydraulic shock absorber is of the strut type, the damper tube and the piston rod tilt with respect to the vehicle body side attaching bracket. As a result, the dust cover also tilts. At this time, since the dust cover is pushed upward by the extension and retraction of the damper tube in a state of inclining with respect to the vehicle body side attaching bracket, it tends to bow due to this upthrust, and the bowing suppressing effect mentioned in the item (a) is great in the strut type hydraulic shock absorber.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is a front elevational view showing a main part of a strut type hydraulic shock absorber in a rupturing manner;

FIG. 2 is an enlarged cross-sectional view of the main part in FIG. 1;

FIGS. 3A and 3B show a dust cover in a shock absorber attached state, wherein FIG. 3A is a cross-sectional view of a whole, and FIG. 3B is an enlarged cross-sectional view of a main part; and

FIGS. 4A to 4C are cross-sectional views showing an extension and retraction state of the dust cover.

### DESCRIPTION OF THE PREFERRED EMBODIMENTS

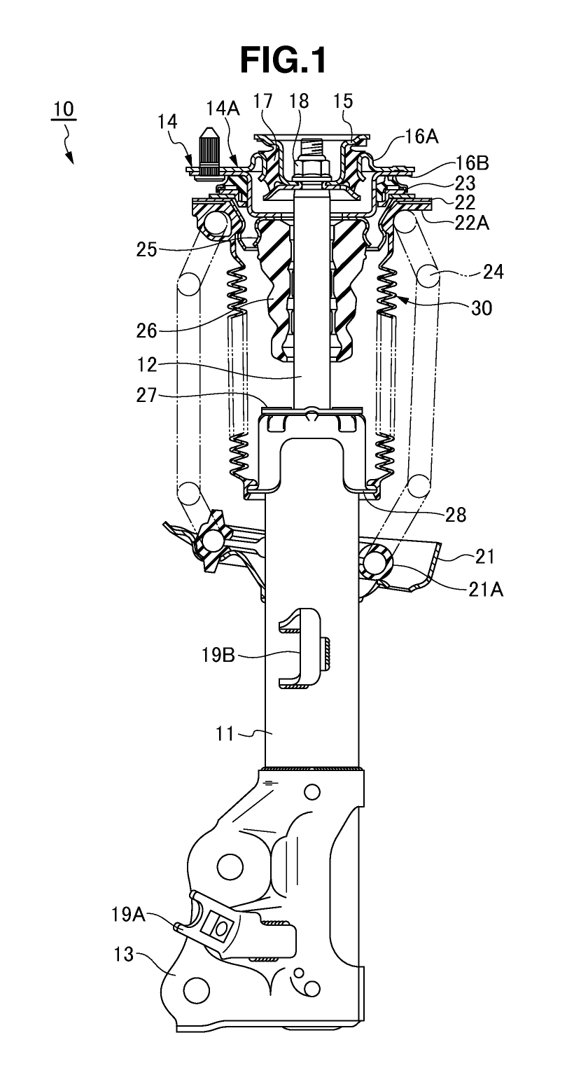

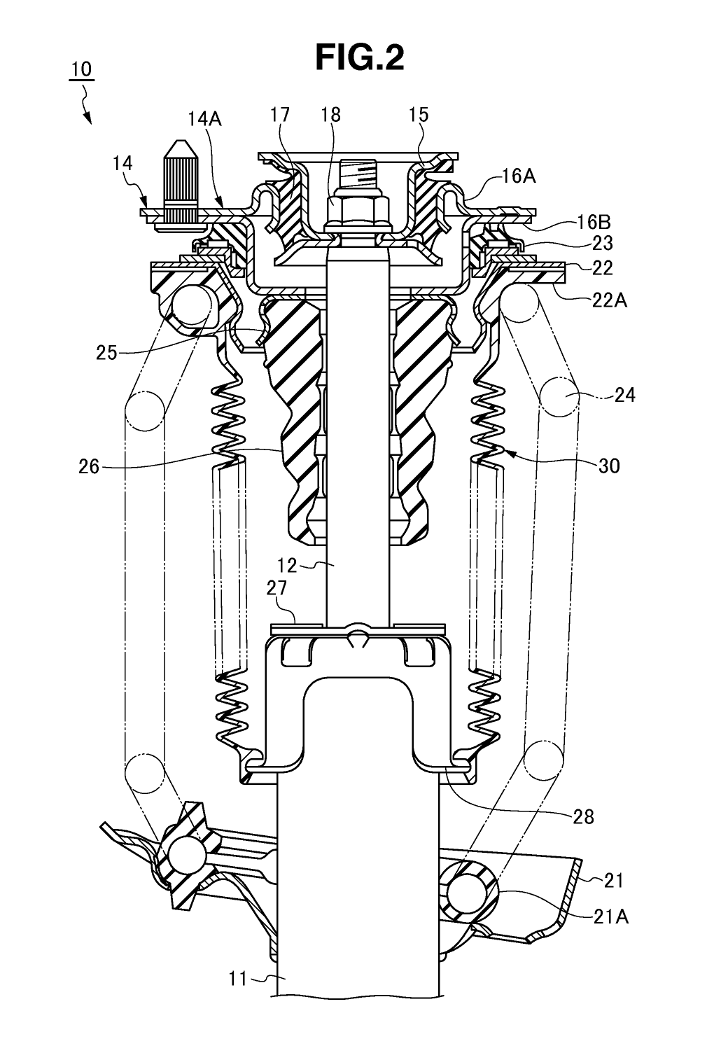

A hydraulic shock absorber 10 shown in FIGS. 1 and 2 is of a strut type. It is structured such that a piston rod 12 is inserted into a cylinder (not shown) which is embedded in a damper tube 11. A wheel side attaching bracket 13 is provided in the damper tube 11 so as to be connected to a wheel, and is provided with a vehicle body side attaching bracket 14 in the piston rod 12 protruding out of the damper tube 11 so as to be attached to a vehicle body. In this case, the vehicle body side attaching bracket 14 consists of a mount rubber assembly 14A consisting of a stay 15, upper and lower mount bases 16A and 16B, and a mount rubber 17, and is structured by inserting the stay 15 of the mount rubber assembly 14A into an upper end side small diameter portion of the piston rod 12 so as to be fastened by a nut 18.

The hydraulic shock absorber 10 is provided with a lower arm attaching portion 19A in the wheel side attaching bracket 13, is provided with a lower arm (not shown) between the hydraulic shock absorber 10 and a vehicle body, and makes the damper tube 11 and the piston rod 12 tiltable with respect to the vehicle body side attaching bracket 14. In this case, the hydraulic shock absorber 10 is provided with a stabilizer attaching portion 19B in the damper tube 11, and a stabilizer (not shown) can be attached thereto.

The hydraulic shock absorber 10 is structured such that the damper tube 11 and the piston rod 12 are set to a shock absorber main body, and a coil spring 24 is interposed between a lower spring sheet 21 which is fixed to an outer periphery of the damper tube 11 and an upper spring sheet 22 with a thrust bearing 23 which is installed around the piston rod 12 and is fixed to the vehicle body side attaching bracket 14 by a light press fitting or the like so as to be supported on its back face. Specifically, the coil spring 24 is supported to the lower spring sheet 21 via a sheet rubber 21A and is supported to the upper spring sheet 22 via a sheet rubber 22A.

The hydraulic shock absorber 10 is provided with a bump rubber 26 which is inserted and attached into a lower portion close to the vehicle body side attaching bracket 14 of the piston rod 12 so as to firmly press itself against the lower portion, in a bump rubber attaching body 25 which is welded to a lower surface of the vehicle body side attaching bracket 14. The hydraulic shock absorber 10 regulates a maximum compression stroke by bringing the bump rubber 26 into contact with a bump stopper cap 27 in an upper end surface of the damper tube 11, during a maximum compression.

The hydraulic shock absorber 10 is provided with a dust cover 30 in an annular space in an inner side of the coil spring 24 and in an outer side of the bump rubber 26. The dust cover 30 is integrally formed in a lower end portion of the sheet rubber 22A which is provided in the upper spring sheet 22. A lower end portion of the dust cover 30 is locked to a cover receiver 28 which is provided in the damper tube 11, and the damper tube 11 and the piston rod 12 are covered with the dust cover 30.

In other words, the hydraulic shock absorber 10 extends and retracts in such a manner as to absorb an impact force which the vehicle receives from the road surface, by a snapping force of the coil spring 24. Further, the hydraulic shock absorber 10 quickly suppresses an extension and retraction vibration by a damping force which is generated by a piston valve apparatus provided in the piston, a base valve apparatus provided in the cylinder and the like, when the piston (not shown) moves up and down in accordance with the extension and retraction.

Accordingly, in the hydraulic shock absorber 10, the following structure is provided, in order to make it possible to easily manufacture the dust cover 30 which can suppress the bowing.

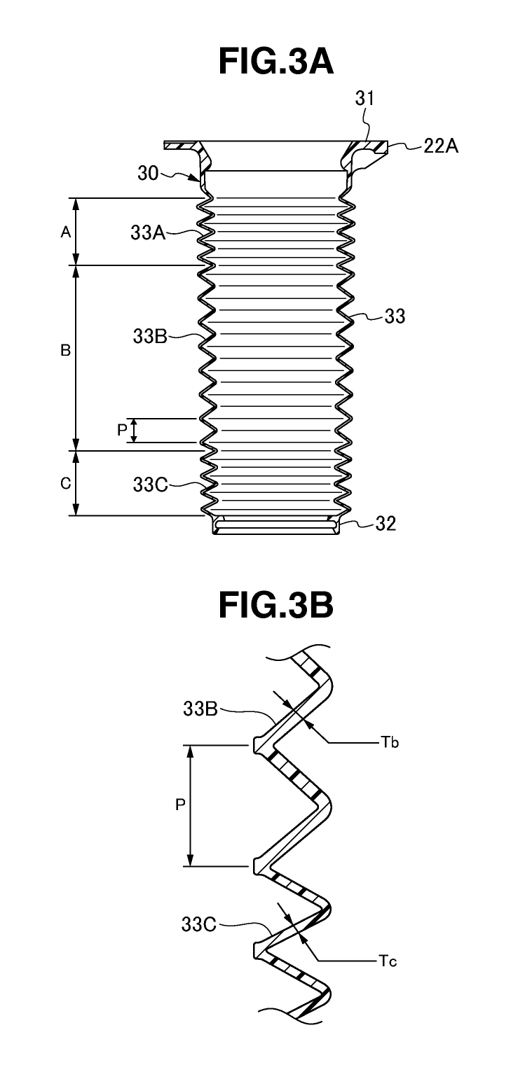

The dust cover 30 is structured, as shown in FIGS. 3A and 3B, such that an upper end portion 31 is set to a side of the sheet rubber 22A, a lower end portion 32 is set to a side locked to the cover receiver 28, and a bellows portion 33 is provided between the upper end portion 31 and the lower end portion 32. The dust cover 30 is a tubular formed body structured such that the bellows portion 33 is formed by alternately arranging a lot of annular crest or ridge portions M and a lot of annular root portions V in a longitudinal direction.

The dust cover 30 is structured such that the bellows portion 33 is divided into upper, intermediate and lower three regions A to C extending in the longitudinal direction. Thicknesses Ta and Tc of bellows portions 33A and 33C in the upper region A and the lower region C are made thin, and a thickness Tb of a bellows portion 33B in the intermediate region B is made thick. The thickness Tb of the bellows portion 33B in the intermediate region B is made 5 to 15% thicker than the thicknesses Ta and Tc of the bellows portions 33A and 33C in the upper region A and the lower region C, and is more preferably made 10% thicker. For example, on the assumption that Ta and Tc are 1 mm, Tb is set to 1.1 mm.

In the present embodiment, the bellows portion 33 is formed as a straight tubular shape in its whole shape, and the respective outer diameters as well as the respective inner diameters of the bellows portions 33A to 33C are made approximately equal to each other. Further, the bellows portion 33 is structured such that pitches P of the ridges of the bellows portions 33A to 33C are made equal to each other in a free state.

The dust cover 30 is structured such that respective upper and lower quarters of a whole length of the bellows portion 33 are set to the bellows portions 33A and 33C of the upper region A and the lower region C, and the remaining half is set to the bellows portion 33B of the intermediate region B. Alternatively, the dust cover 30 is structured such that respective upper and lower thirds of the whole length of the bellows portion 33 are set to the bellows portions 33A and 33C of the upper region A and the lower region C, and the remaining third is set to the bellows portion 33B of the intermediate region B. For example, in the case that the whole of the bellows portion 33 consists of twenty ridges, six ridges of the upper region A are set to the bellows portion 33A, seven ridges of the lower region C are set to the bellows portion 33C, and seven ridges of the intermediate region B are set to the bellows portion 33B.

The dust cover 30 is formed by metal molding a rubber such as NBR between an outer die and an inner die. The metal die (the outer die and the inner die) can be manufactured by extra cutting a whole of a formed portion of the bellows portion 33B (having a large thickness) in the intermediate region B in comparison with a formed portion of the other bellows portions 33A and 33C, or can be manufactured by molding a synthetic resin such as a polyolefin thermoplastic elastomer (TPO), polyethylene, or polyester elastomer in accordance with a parison control so that the intermediate portion becomes thicker, and a high precision is not required. Precisions of an angle of a ridge and a height of a ridge of the formed portion of the bellows portion 33B in the metal die may be within a general tolerance which is the same as that of the formed portions of the other bellows portions 33A and 33C, and may be structured such that the thickness of the bellows portion 33B is thicker as a whole, thereby achieving a great rigidity. The dimensions such as the outer diameter and the inner diameter of each of the bellows portions 33A to 33C are hardly changed with each other, and may be set to a range within a general tolerance.

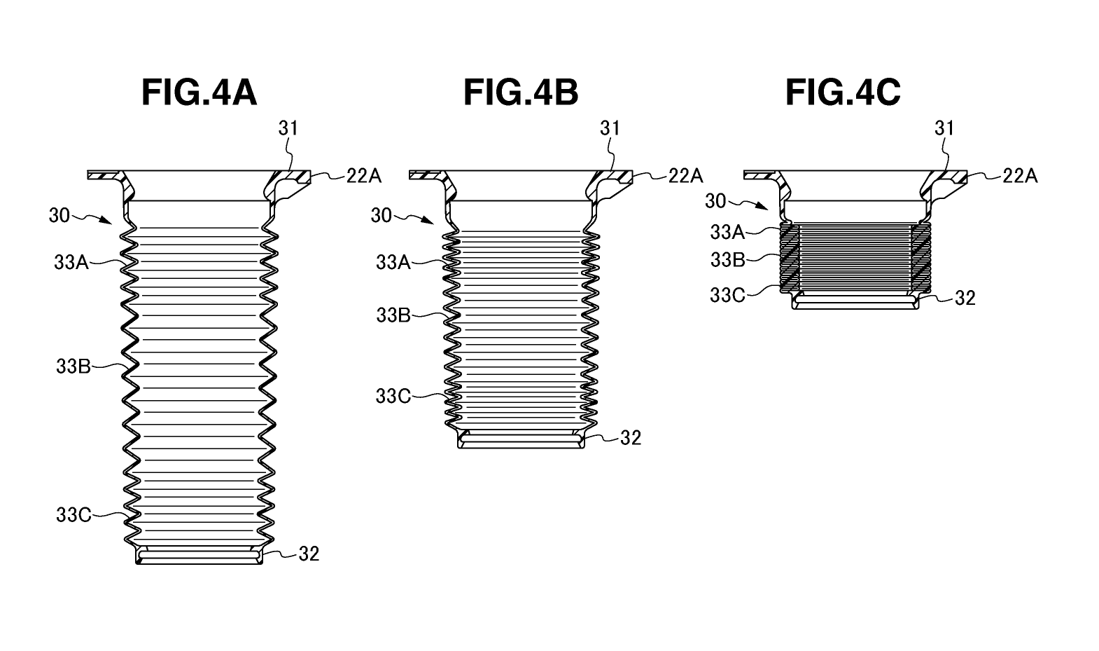

A state in which the bellows portion 33 of the dust cover 30 is extended and retracted is shown in FIGS. 4A to 4C. FIG. 4A shows a small compression state of the dust cover 30 which is embedded in the hydraulic shock absorber 10 in a fully extending state before being attached to the vehicle, FIG. 4B shows an intermediate compression state of the dust cover 30 which is within the hydraulic shock absorber 10 in an empty state in which it is attached to the vehicle, and FIG. 4C shows a maximum compression state of the dust cover 30 which is within the hydraulic shock absorber 10 at a maximum compression after it is attached to the vehicle. In this case, the dust cover 30 in a free state is not illustrated; however, the pitches P of the ridges of the respective bellows portions 33A to 33C of the dust cover 30 in a free state are equal to each other as mentioned above.

In accordance with the present embodiment, the following operations and effects can be achieved.

(a) The thicknesses Ta and Tc of the bellows portions 33A and 33C in the upper region A and the lower region C are made thin (small rigidity), and the thickness Tb of the bellows portion 33B in the intermediate region B is made thick (large rigidity). Accordingly, a whole length of the dust cover 30 is shortened by deflecting the bellows portions 33A and 33C in the upper region A and the lower region C having the small rigidity and being easily deflected in advance, and the bellows portion 33B in the intermediate region B having the large rigidity and being hard to deflect is thereafter deflected.

The bellows portions 33A and 33C in the upper region A and the lower region C are easily bent at such a degree that the rigidity is small, but are hard to bend at such a degree that they are shorter in comparison with the whole length of the dust cover 30, and are immediately folded at such a degree that the rigidity is small, thereby being suppressed from bowing.

The bellows portion 33B in the intermediate region B is hard to bow at such a degree that the rigidity is large, is made shorter in comparison with the whole length of the dust cover 30, and starts being folded after the whole length of the dust cover 30 becomes short. Accordingly, even if only the bellows portion 33B in the intermediate region B is deflected to one side in a radial direction, a protruding amount in the radial direction thereof is not large, and it is possible to suppress the bowing.

In other words, the general dust cover 30 has the maximum protruding amount to the radial direction in the intermediate portion in the longitudinal direction so as to tend to generate the bowing, starts bending from the bellows portions 33A and 33C in the upper region A and the lower region C, and bends largely by the bellows portion 33B in the intermediate region B so as to interfere with the peripheral coil spring 24 or the like. On the contrary, in the present invention, even if the bellows portions 33A and 33C in the upper region A and the lower region C bend to some extent in a process of being folded, the bellows portion 33B in the intermediate region B having a large rigidity is not folded yet and does not generate the bowing. Further, if the bellows portions 33A and 33C in the upper region A and the lower region C finish being folded, the remaining short bellows portion 33B in the intermediate region B is hard to bend due to the large rigidity, the protruding amount to the radial direction is not large due to the short length, and the bowing is not generated. Accordingly, a whole of the dust cover 30 is inhibited from being bowed and can extend and retract.

(b) It is sufficient to make the thicknesses Ta and Tc of the bellows portions 33A and 33C in the upper region A and the lower region C thin as a whole, and make the thickness Tb of the bellows portion 33B in the intermediate region B thick as a whole, and a high precision is not required in the molding die and the manufacturing method. It is possible to easily manufacture the dust cover 30 which can suppress the bowing.

(c) The thickness Tb of the bellows portion 33B in the intermediate region B is made 5 to 15% thicker than the thicknesses Ta and Tc of the bellows portions 33A and 33C in the upper region A and the lower region C. It is possible to securely suppress the bowing of the dust cover 30 by the item (a) mentioned above.

(d) When the hydraulic shock absorber 10 is of the strut type, the damper tube 11 and the piston rod 12 tilt with respect to the vehicle body side attaching bracket 14. As a result, the dust cover 30 also tilts. At this time, since the dust cover 30 is pushed upward by the extension and retraction of the damper tube 11 in a state of inclining with respect to the vehicle body side attaching bracket 14, it tends to bow due to this upthrust, and the bowing suppressing effect mentioned in the item (a) is great in the strut type hydraulic shock absorber.

As heretofore explained, embodiments of the present invention have been described in detail with reference to the drawings. However, the specific configurations of the present invention are not limited to the illustrated embodiments but those having a modification of the design within the range of the presently claimed invention are also included in the present invention.

In accordance with the present invention, there is provided a dust cover structure of a hydraulic shock absorber covering a piston rod of the hydraulic shock absorber with a bellows-like dust cover. The dust cover is divided into three regions, upper, intermediate and lower regions extending in a longitudinal direction. The thicknesses of bellows portions in the upper region and the lower region are made thin, and a thickness of a bellows portion in the intermediate region is made thick. Accordingly, in a dust cover structure of a hydraulic shock absorber, it is possible to easily manufacture a dust cover which can suppress bowing.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A dust cover structure of a hydraulic shock absorber covering a piston rod of the hydraulic shock absorber with a bellows-like dust cover,
wherein the dust cover is divided into upper, intermediate and lower regions extending in a longitudinal direction, thicknesses of bellows portions in the upper region and the lower region are made thin, and a thickness of a bellows portion in the intermediate region is made thick.

2. The dust cover structure of a hydraulic shock absorber according to claim 1, wherein the thickness of the bellows portion in the intermediate region is made 5 to 15% thicker than the thicknesses of the bellows portions in the upper region and the lower region.

3. The dust cover structure of a hydraulic shock absorber according to claim 1, wherein the hydraulic shock absorber is of a strut type.

4. The dust cover structure of a hydraulic shock absorber according to claim 2, wherein the hydraulic shock absorber is of a strut type.

5. The dust cover structure of a hydraulic shock absorber according to claim 1, wherein the dust cover is structured such that upper and lower quarters of a whole length of the bellows portion are set to bellows portions in the upper region and the lower region, respectively, and the remaining half is set to a bellows portion in the intermediate region.

6. The dust cover structure of a hydraulic shock absorber according to claim 2, wherein the dust cover is structured such that upper and lower quarters of a whole length of the bellows portion are set to bellows portions in the upper region and the lower region, respectively, and the remaining half is set to a bellows portion in the intermediate region.

7. The dust cover structure of a hydraulic shock absorber according to claim 3, wherein the dust cover is structured such that upper and lower quarters of a whole length of the bellows portion are set to bellows portions in the upper region and the lower region, respectively, and the remaining half is set to a bellows portion in the intermediate region.

8. The dust cover structure of a hydraulic shock absorber according to claim 4, wherein the dust cover is structured such that upper and lower quarters of a whole length of the bellows portion are set to bellows portions in the upper region and the lower region, respectively, and the remaining half is set to a bellows portion in the intermediate region.

9. The dust cover structure of a hydraulic shock absorber according to claim 1, wherein the dust cover is structured such that upper and lower thirds of a whole length of the bellows portion are set to bellows portions in the upper region and the lower region, respectively, and the remaining third is set to a bellows portion in the intermediate region.

10. The dust cover structure of a hydraulic shock absorber according to claim 2, wherein the dust cover is structured such that upper and lower thirds of a whole length of the bellows portion are set to bellows portions in the upper region and the lower region, respectively, and the remaining third is set to a bellows portion in the intermediate region.

11. The dust cover structure of a hydraulic shock absorber according to claim 3, wherein the dust cover is structured such that upper and lower thirds of a whole length of the bellows portion are set to bellows portions in the upper region and the lower region, respectively, and the remaining third is set to a bellows portion in the intermediate region.

12. The dust cover structure of a hydraulic shock absorber according to claim 4, wherein the dust cover is structured such that upper and lower thirds of a whole length of the bellows portion are set to bellows portions in the upper region and the lower region, respectively, and the remaining third is set to a bellows portion in the intermediate region.
